(19) United States
(12) Patent Application Publication
(10) Pub. No.: US 2025/0293897 A1
(43) Pub. Date: Sep. 18, 2025

(54) AUTOMATED SEQUENCING OF COMMUNICATION SESSIONS

(71) Applicant: Microsoft Technology Licensing, LLC, Redmond, WA (US)

(72) Inventor: Amer Aref Hassan, Kirkland, WA (US)

(21) Appl. No.: 18/606,511

(22) Filed: Mar. 15, 2024

(51) Int. Cl. H04L 12/18

(52) U.S. Cl. CPC H04L 12/1818; H04L 12/1831

(57) ABSTRACT

Disclosed in some examples are methods, systems, and machine-readable mediums that enhance the efficiency and continuity of network-based communication sessions by automatically linking related communication sessions. This system may utilize a set of one or more criteria to determine the relationships between communication sessions intelligently and automatically. The criteria may include temporal proximity of the sessions, commonality of attendees, similarities in communication session content and/or topics discussed (e.g., determined from titles, metadata, shared documents, agendas, and thematic content derived from titles or agendas), historical behavior patterns, and/or the like. Additionally, the system allows for manual linking by an organizer, participant, and/or administrator.

### TECHNICAL FIELD

Embodiments pertain to network-based communication sessions. Some embodiments relate to automated sequencing of multiple network-based communication sessions.

### BACKGROUND

Network-based communication services have revolutionized the way individuals and organizations interact and collaborate. These services leverage the vast infrastructure of the internet to facilitate real-time exchange of information across geographically dispersed locations. One type of network-based communication is a network-based meeting, which enable participants to connect via audio, video, and data sharing, thus simulating a face-to-face meeting environment. The advent of high-speed internet and advancements in multimedia technology have significantly enhanced the quality and reliability of these virtual communication sessions. Network-based communication platforms integrate various functionalities such as screen sharing, virtual whiteboards, and session recording, making them indispensable tools for business, education, and personal use. The ubiquity of mobile devices and the development of cloud computing have further expanded the accessibility of network-based communication services, allowing users to join communication sessions from virtually anywhere, provided they have internet connectivity.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a diagram of linking of network-based communication sessions according to some examples of the present disclosure.

FIG. 2 illustrates a network-based communication system in some examples of the present disclosure.

FIG. 3 illustrates a GUI of a network-based communication session that was provided by a network-based application.

FIG. 4 illustrates a GUI of a network-based communication session that was provided by a network-based application.

FIG. 5 illustrates a flowchart of a method of linking multiple network-based communication sessions according to some examples of the present disclosure.

FIG. 6 illustrates a flowchart of a method of providing an automatic join to a linked communication session according to some examples of the present disclosure.

FIG. 7 is a block diagram illustrating an example of a machine upon which one or more embodiments may be implemented.

### DETAILED DESCRIPTION

In the realm of network-based communication sessions, a notable inefficiency arises when users are scheduled for multiple, related communication sessions that occur in succession. This scenario is common in professional settings where strategic pre-communication sessions are convened among a subset of participants prior to a larger, main communication session. The issue at hand is the disruption and time lost when participants must conclude the initial communication session and then navigate to a separate application, such as a calendar or email client, to locate the joining information for the subsequent communication session. This process is not only cumbersome but also introduces a break in the workflow, as attendees must manually exit one interface and enter another. The interruption can lead to delays, as participants may struggle to promptly find the necessary details among a plethora of calendar entries or emails, especially if they are already running close to the scheduled start time of the next communication session.

Furthermore, the transition between consecutive communication sessions presents a challenge in the continuity of communication session artifacts, such as notes, documents, or action items discussed in the first communication session. These artifacts provide context and content of the following communication session, yet there is no seamless mechanism to transfer this information directly to the subsequent communication session space. Participants are left to manually compile and share these artifacts, which can be time-consuming and prone to errors or omissions. This gap in the workflow not only hinders productivity but also affects the quality of collaboration, as valuable insights or decisions from the first communication session may not be readily accessible or top-of-mind for attendees as they enter the second communication session. The lack of an integrated solution to link related communication sessions and their respective content represents a significant pain point for users who frequently engage in back-to-back, interconnected network-based communication sessions.

Disclosed in some examples are methods, systems, and machine-readable mediums that enhance the efficiency and continuity of network-based communication sessions by automatically linking related communication sessions. This system may utilize a set of one or more criteria to determine the relationships between communication sessions intelligently and automatically. The criteria may include temporal proximity of the sessions, commonality of attendees, similarities in communication session content and/or topics discussed (e.g., determined from titles, metadata, shared documents, agendas, and thematic content derived from titles or agendas), historical behavior patterns, and/or the like. Additionally, the system allows for manual linking by an organizer, participant, and/or administrator.

Upon the conclusion of a linked communication session, the system seamlessly transitions participants to the next communication session either automatically or through a user interface prompt, without the need for manual navigation to calendars or emails. This transition is not only smooth but also preserves the context by making all artifacts from the first communication session, such as notes, documents, and action items, readily available to participants of the first communication session in the subsequent communication session space. For participants who attend both communication sessions, the system may merge artifacts like transcripts and recordings, creating a comprehensive record of the discussions.

As a result of the merged contexts, network-based communication services equipped with an Al chatbot may utilize context from both communication sessions to assist users who attended both communication sessions. This AI chatbot may provide intelligent suggestions and relevant hints throughout the course of the communication sessions. For instance, if a list of topics was agreed upon in the first communication session to be addressed in the second, the AI chatbot actively monitors the discussion to ensure all topics are covered. Towards the end of the second communication session, it can prompt the attendees regarding any unresolved or unaddressed topics, thereby ensuring a thorough and productive communication session experience. In addition, the chatbot may answer questions from participants that attended both sessions using information from both sessions.

The present disclosure thus improves the functioning of the computer system by describing a specific improvements to the user interface of the network-based communication service by providing users the opportunity to automatically join related communication sessions upon the conclusion of a first communication session. This solves the problems of the prior art systems which required users to hang up a first meeting, then find and access the join information for the related meeting. The present disclosure provides technical solutions to these technical problems of inefficient user interfaces by utilizing a user-friendly and highly intuitive user interface to automatically link related communication sessions and then automatically join a next meeting in a group of two or more related communication sessions. This allows participants to more quickly access the related network-based communication session, thereby improving the efficient functioning of the computer. The disclosed examples thus increase the efficiency with which users can transition between communication sessions.

In addition, by linking artifacts the disclosure provides even more efficient user interactions. This also prevents the participants in a later of two linked communication sessions from having to search for meeting content from the first of two linked communication sessions-potentially distracting the participant from what is happening in the second communication session. This also improves the efficiency of the user interface.

In some examples, communication sessions may be linked via the communication session data structures. For example, each network-based communication session may be represented by a data structure that stores one or more session attributes. Example attributes may include one or more of: a unique identifier, title, start and end times, participant list, a collection of associated artifacts, or the like. In some examples, each communication session data structure may include a list of one or more linked communication sessions. The list may include pointers or identifiers of the linked communication sessions. In other examples, the communication session data structures may be stored in a relational database with tables for communication sessions, participants, artifacts, and communication session links. The communication session links table may include keys referencing the linked communication sessions. In some examples, the links may be specific only to certain participants. That is, the communication session data structure may be participant-specific such that two sessions may be linked for a first participant in one or both sessions, but not a second participant in one or both sessions.

In addition, each communication session data structure may contain or point to additional artifacts that are combined artifacts for the communication session and the linked communication sessions. For example, each communication session may have a first transcript artifact for only the first communication session and a second communication session transcript that is the combined transcript of the first and second linked communication session. In other examples, instead of having multiple artifacts, the communication session specific artifacts may have links inserted into them that, when interpreted by the communication application, may then incorporate additional artifacts. For example, the first communication session transcript may have a link to the second communication session transcript. When the first communication session transcript is accessed, the system may also access the second communication session transcript.

In some examples, artifacts from communication sessions may be managed through a content management system (CMS). Each artifact may be tagged with metadata that includes the originating communication session ID. When a communication session concludes, the system checks for linked subsequent communication sessions and transfers the artifacts to the next communication session's workspace. This may be facilitated by an Application Programming Interface (API) that interfaces between the communication session management system and the CMS.

The AI chatbot may maintain a contextual model for each communication session, which may be a structured representation of the communication session's content. This model includes extracted topics, action items, and unresolved issues, and may be built using text analysis of the communication session's transcript and machine learning techniques. The model may be stored in a graph database, which allows for complex relationships between entities and facilitates quick contextual retrieval. The contextual model may be considered a communication session artifact and multiple contextual models for linked communication sessions may be linked as with other artifacts. The chatbot may utilize the contextual model to provide suggestions, answer participant questions, and provide other content for the communication session.

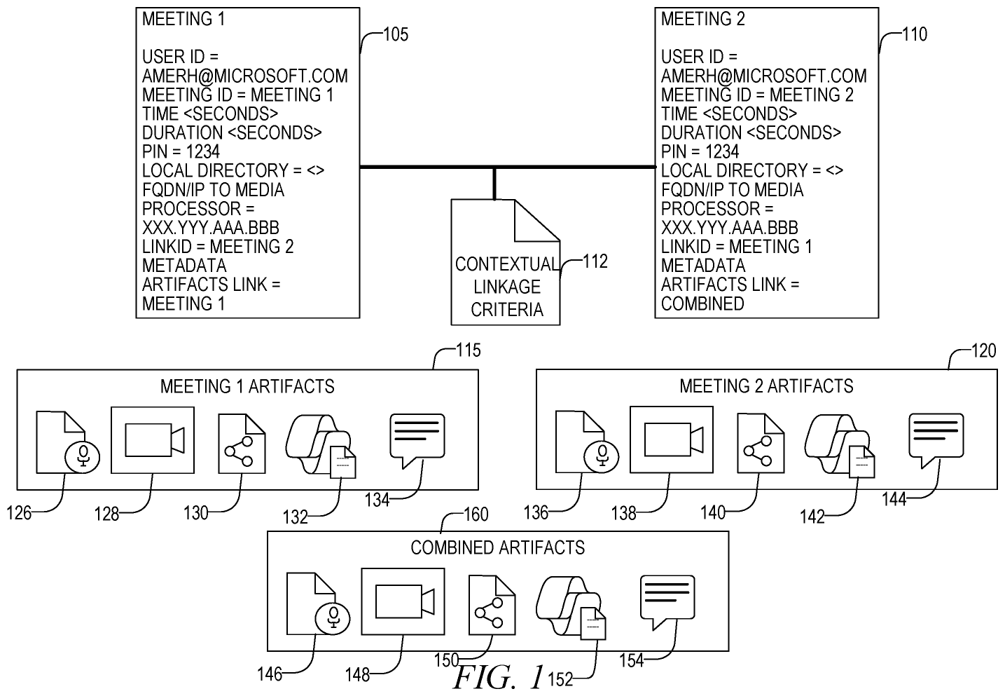

FIG. 1 illustrates a diagram of linking of network-based communication sessions according to some examples of the present disclosure. FIG. 1 illustrates a first network-based communication session data structure 105 and a second network-based communication session data structure 110. These data structures are designed to be linked when they satisfy a specified number (e.g., one or more) contextual linkage criteria 112.

The contextual linkage criteria 112 is a set of one or more conditions that serve as signals as to whether individual communication session records are considered related and thus may be linked together. These criteria are designed to identify sessions that share certain characteristics, making them relevant to each other. The contextual linkage criteria include one or more of, but are not limited to, session temporal proximity criteria, session participant commonality criteria, session content correspondence criteria, and user historical context. A session may be linked when a specified threshold number of criteria are met. In some examples, each criteria may produce a score. For example, a temporal proximity score, a participant commonality score, a session content correspondence score and a user historical context score. The scores may then be weighted and summed. If the weighted sum of the scores is above a predetermined threshold, the network-based communication sessions may be linked. The weights and/or threshold may be prespecified by an administrator, or may be learned by a machine-learning network such as a neural network trained using past communication session data and manual labels indicating whether the sessions should be linked.

The contextual linkage criteria may be global criteria that applies to all conferences to all users or may be user specific. That is, the contextual linkage criteria may vary from user to user according to their preferences and past usage history. As is described herein the assessment of whether a session is to be linked may be particularized for any given user. A same set of multiple network-based communication sessions may be linked for a first participant in the sessions but not a second participant in the sessions.

The session temporal proximity criteria specify a certain temporal proximity between sessions, indicating that sessions occurring close in time may be linked. The temporal proximity criteria within the linkage criteria of network-based communication sessions are a set of parameters used to determine the closeness in time between two or more communication sessions for the purpose of linking them. This criterion specifies a particular timeframe within which sessions must occur to be considered for linkage. For instance, sessions that take place within a few hours or days of each other may meet the temporal proximity criteria, suggesting that they are part of a continuous dialogue or a series of related events. In some examples, sessions within a prespecified time of each other may be considered proximity. The prespecified time may be set by an administrator, user, or the like. In examples in which the proximity criteria produces a score, the score may be based upon the time difference between the communication sessions with sessions closer in time receiving higher scores. The temporal proximity criteria ensure that sessions which are temporally related are recognized as potentially relevant to one another, allowing users to easily track the progression of discussions, decisions, and shared information over a period that is contextually meaningful.

The session participant commonality criteria within the linkage criteria are parameters used to identify and link network-based communication sessions based on the overlap of participants in those sessions. This criterion is a signal that indicates that sessions with participant group overlaps are more likely to be linked. For example, this factor considers whether communication sessions share a specified number or percentage of common participants indicating a continuity of involvement or interest among the same group of individuals across different sessions. The degree of participant overlap required to satisfy the session participant commonality criteria may be set by an administrator, participant, or the like. In examples in which this criteria produces a score, the score may be related to the number or percentage of common participants such that the score increases as the number or percentage of common participants increases.

The session content correspondence criteria are criteria that determine whether the similarity or relatedness of the content discussed, shared, or generated during those sessions is such that the sessions are likely related. This criterion evaluates the extent to which the subject matter, topics, documents, multimedia files, or any other form of content from one session corresponds to that of another. To satisfy the session content correspondence criteria, sessions must exhibit a specified level of commonality in their content, which could be thematic, topical, or based on specific keywords, projects, or objectives that are shared across the sessions. The content correspondence can be identified through various means, such as analyzing the communication session titles, proposed agendas, contents of shared files, or using AI algorithms to detect similarities in the discussions or presentations. For example, the session titles, proposed agendas, contents of shared files, and the like may be used by a large language model (LLM) to determine topics discussed. The topics may be grouped into groups of related topics using lists of topics and assigned groups. Topics from meeting A that match the same groups as meeting B may be considered matching. A certain number or percentage of topic overlap may indicate the communication sessions are to be linked. For scoring purposes, the LLM may produce a measure of similarity of topics that may be used as the score. This criterion may allow for linking sessions that, while they may not be temporally proximate or have common participants, are nonetheless relevant to each other due to the continuity or overlap in their content, thereby providing a comprehensive and connected view of related communication sessions.

Historical user context as a criterion within the linkage criteria for network-based communication sessions refers to the consideration of a user's past interactions, behaviors, preferences, and contributions in determining the relevance and linkage of communication sessions. This criterion leverages the historical data associated with a user to establish connections between sessions that are pertinent to that user's historical engagement. For instance, if documents from a first communication session related to a first subject are frequently accessed by a participant during, or shared in, a second communication session related to a second subject, the system may determine that the communication sessions are related. In other examples, if a user frequently jumps from a first repeating session to a second repeating session, the system may automatically link those sessions.

Each network-based communication session data structure may be specific to a session, or may be specific to a particular user. That is, a structure specific to a session may include a list of users and may include a link to one or more linked network-based communication session data structures. In some examples where the session linkage is specific to particular users, the session data structure may have a linked list of link data structures that specify a user along with one or more linked sessions. In some examples, where the structure is specific to the users, the linkage may be a link to the linked session for that user.

The network-based communication session data structure, as shown in FIG. 1, is specific to a user and may include a user id, a communication session id, a start time of the session, a scheduled duration of the session, an access code or PIN for authenticating to the session, a local directory for storing artifacts of the session generated locally, a fully qualified domain name (FQDN) or IP address to a media processor of the network-based service that hosts the session, a link to related sessions, a set of metadata of the ongoing session (e.g., the elapsed time, participants, and the like), and a link to a location where the session artifacts are shared.

Each network-based communication session data structure may include a collection of artifacts associated with the respective communication session. For the first network-based communication session data structure 105, the artifacts, labeled as element 115, include transcripts 126, recordings 128, shared files 130, AI chatbot history and context 132, and chat logs 134. The AI chatbot history and context may include a context of the chatbot-such as questions asked, answers provided, and the like. Similarly, the second network-based communication session data structure 110 has its own set of artifacts, labeled as element 120, which comprise transcripts 136, recordings 138, shared files 140, AI chatbot history and context 142, and chat logs 144.

When the first and second network-based communication session data structures are linked based on the contextual linkage criteria 112, the artifacts from both sessions can be combined or shared as combined artifacts, indicated by element 160. Combined artifacts may include combined transcripts 146, combined recordings 148, combined shared files 150, combined AI chatbot history and context 152, and combined chat logs 154. Making the combined artifacts available for participants of both sessions facilitates a comprehensive view of related sessions for users who participated in both communication sessions. The combined artifacts may be presented in various ways. For example, they may be grouped together within a user interface (UI) element associated with either the first or the second communication session, where typically only a single communication session's artifacts would be found. In other instances, the artifacts may be physically combined into a single file, such as merging transcripts or recordings from both sessions into one document or audio file, respectively.

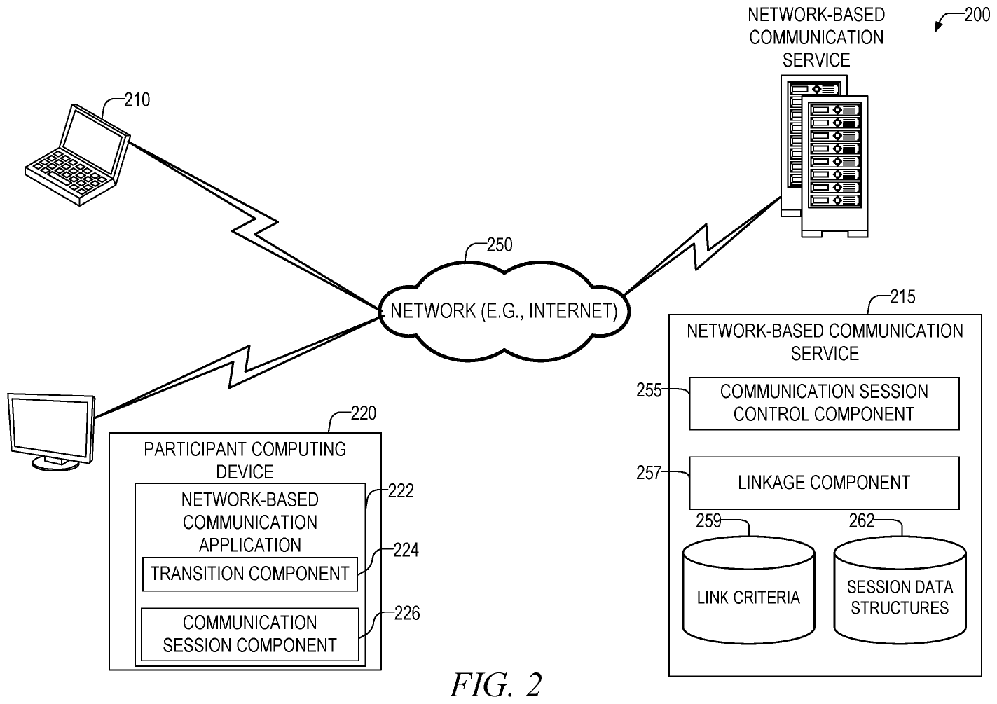

FIG. 2 illustrates a network-based communication system 200 in some examples of the present disclosure. Network-based communication system may facilitate network-based communication sessions over a network 250, such as the Internet. The system includes a network-based communication service 215 that provides the infrastructure and services necessary for conducting and managing communication sessions. Within this system, participant computing devices 210 and 220 are equipped with instances of a network-based communication application 222. The network-based communication application instances are responsible for the client-side operations of the communication sessions. An application instance is a specific occurrence of an application running on a computing device. When an application is executed, the operating system allocates memory and resources for that particular execution, which becomes an instance of the application. Each instance operates independently, allowing multiple instances of the same application to run simultaneously without interfering with one another. The network-based communication application 222 may be a dedicated application or a browser-based application served from a network-based service such as the network-based communication service 215.

The communication session component 226 of the network-based communication application 222 on each participant computing device handles tasks such as user interface display and management, session setup, user interface provision, media capture and encoding, and the transmission and reception of audio/video streams to provide network-based communication sessions in conjunction with the network-based communication service 215. The network-based communication service 215 includes a communication session control component 255, which facilitates server-side operations such as participant authorization, media stream distribution, session management functions like starting and ending sessions, and resource management to provide server-side resources for network-based communication sessions.

A transition component 224 is integrated into the network-based communication application 222, which enables users to move seamlessly between linked network-based communication sessions. This can be achieved through a graphical user interface (GUI) that allows manual transitions by the user or through an automated transition process. In some examples, where a current communication session is linked to multiple communication sessions that are beginning or about to begin (e.g., within a predetermined time period), the GUI may provide a selection method (e.g., a dropdown box) allow the user to select a particular communication session to automatically join. To transition the user, transition component 224 may close a communication channel between a computing device of the user and the first network-based communication session and join the second network-based communication session by opening a second communication channel between the computing device of the user and the second network-based communication session. In some examples, the communication channel may be a connection to a media processor of the network-based service. In some examples, the second communication channel may be opened before the first communication channel is closed, thereby preventing any interruption in communication.

The linkage component 257 determines related communication sessions to link. The linkage component 257 uses contextual linkage criteria stored in a data store 259 to determine the relationships between sessions, which are then stored in communication session data structures 262. The criteria used by the linkage component 257 can include rules, conditions, or algorithms that assess various factors such as temporal proximity, participant commonality, historical commonality, and content correspondence to link sessions contextually.

Data structures can be linked using various techniques, such as through pointers or indexes; special tables or databases; organizing a database or table that holds the data structures to reflect the linkage; references; foreign keys linking tables together; hyperlinks; or the like. By utilizing these linking techniques, the network-based communication system 200 can create a web of interconnected sessions, making it easier for users to navigate through related content and enhancing the overall communication experience.

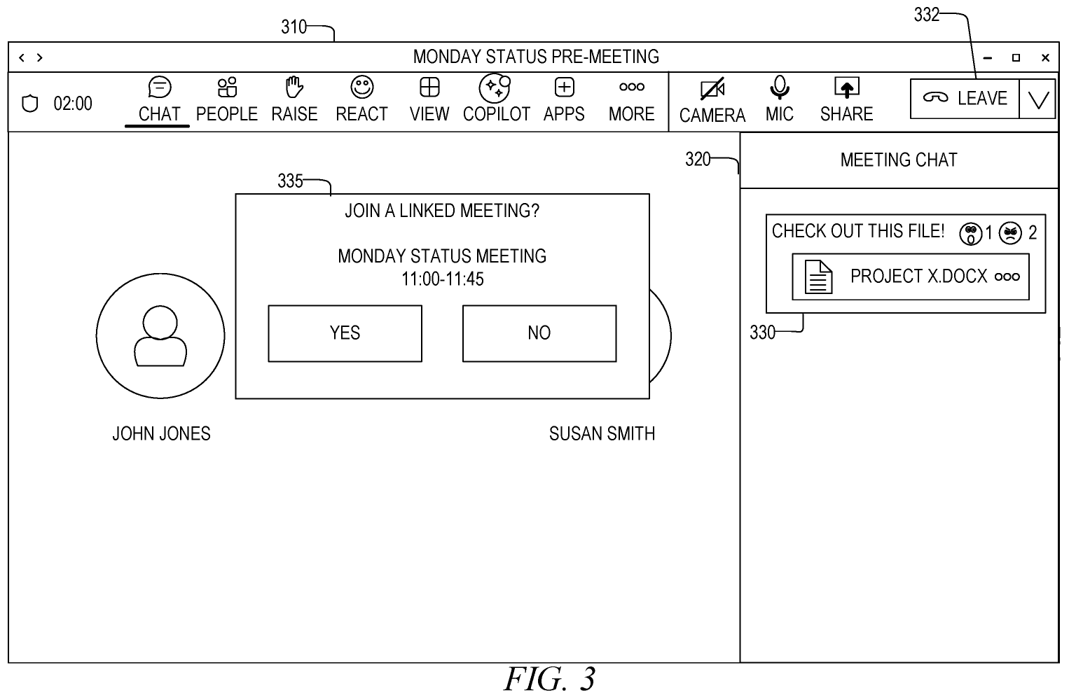

FIG. 3 illustrates a GUI 310 of a network-based communication session that was provided by a network-based application. The GUI 310 displays the communication session title in a window title, a status bar with time, controls for showing who is in attendance, showing or hiding a chat window, raising your hand, creating breakout rooms, and accessing a menu with additional controls. Other controls include a button to start or stop the video, mute or unmute audio, and share files. Chat window 320 is shown with a single message 330 sharing a file. Dialog 335 is presented when a user activates the leave button 332. The system detects a linked network-based communication session that is ongoing or scheduled to begin within a specified time period from the time when the leave button 332 was activated. Upon detection of the linked session, the user is presented with dialog 335 offering them the option of immediately joining the linked communication session.

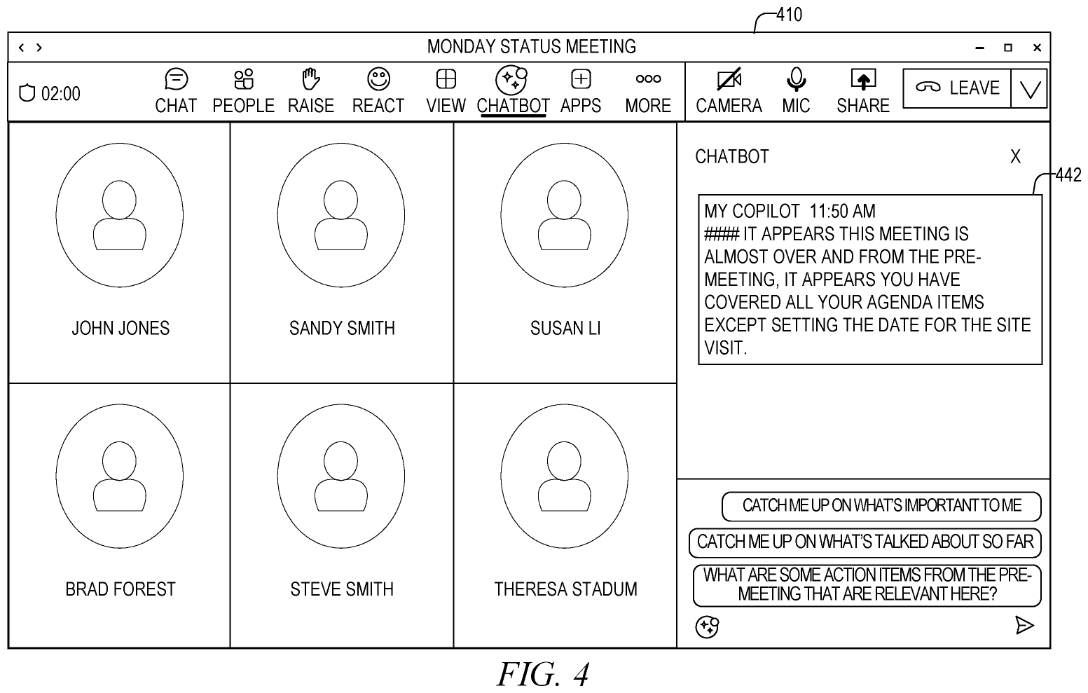

FIG. 4 illustrates a GUI 410 of a network-based communication session that was provided by a network-based application. GUI 410 is a GUI of a successive one of a set of two or more linked communication sessions—e.g., the “Monday Status Communication session” linked from the “Monday Status Pre-Communication session” illustrated in FIG. 3. GUI 410 illustrates the communication session chatbot functionality that includes context from previously held network-based communication sessions in the set of linked sessions. Such context may include transcripts, shared content and the like. In some examples, the chatbot may include context from not-yet-held sessions in the set of linked sessions. Example context from not-yet-held sessions in the set of linked sessions may include agendas, attendee lists, communication session subjects, communication session titles, shared documents, or the like.

The context may be used to answer questions, display reminders, display summaries, or the like. Message bubble 442 reminds the participant that during the pre-communication session the pre-communication session group indicated that they covered all the items they wanted to cover but “setting the date for the site visit.” The chatbot thus utilized the context from the linked communication session and the context from the current communication session to make suggestions to one or more participants. In other examples, participants may ask questions about both communication sessions. For example, a user may ask “what else did we decide we wanted to cover in this communication session?” The chatbot may even have suggested prompts, such as “Catch me up on what's important to me,” “catch me up on what's talked about so far,” and “what are some action items from the pre-meeting that are relevant here?” If a user selects one of these prompts, the chatbot may use the context of the current meeting along with the previous meeting to answer the prompt.

In some examples, the combined context may be provided to only those communication session participants that have attended all the communication sessions that make up the combined context. In other examples, the combined context may be provided to all participants of all linked sessions. In some examples, even though two participants may both be invited to two of the same communication sessions, the sessions may be linked for one participant but not the other. In these examples, the context is only linked for those participants that for which the sessions are linked.

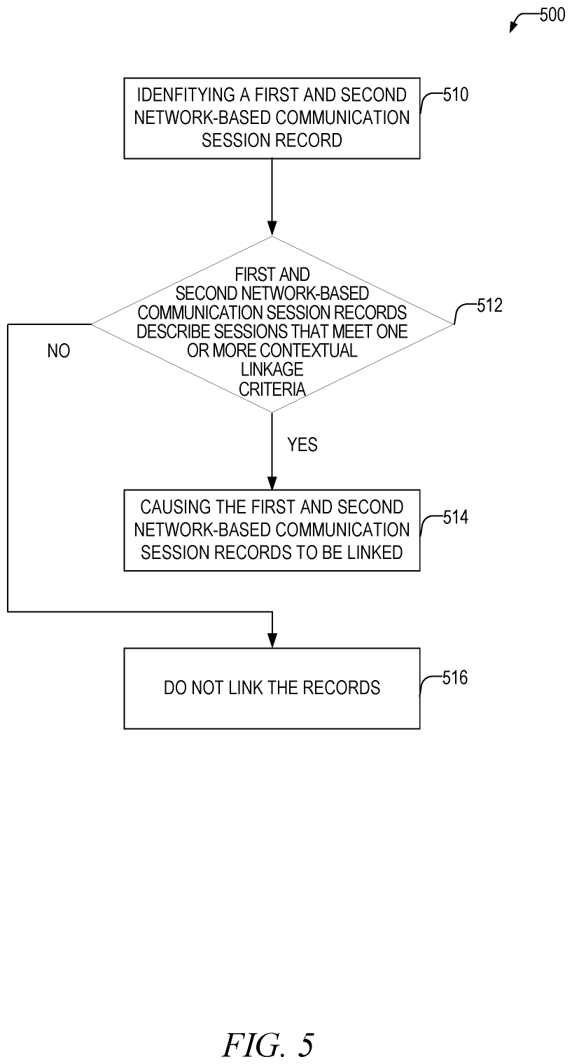

FIG. 5 illustrates a flowchart of a method 500 of linking multiple network-based communication sessions according to some examples of the present disclosure. Sessions may be linked by one or more servers of the network-based communication service or by communication applications. At operation 510 the system may identify first and second network-based communication session records. These may be session records of sessions a particular user is invited to. The identifying step may identify records of communication sessions by performing FIG. 5 for all pairs of sessions that the user is invited to that have not yet happened. In other examples, the system may perform the method for all pairs of sessions that the user is invited to that are scheduled to occur within a prespecified time window.

At operation 512, the system may evaluate whether the pair of sessions meet one or more contextual linkage criteria. The contextual linkage criteria define criteria indicating a relatedness of the communication sessions. The criteria may comprise session temporal proximity criteria indicating a specified temporal proximity, session participant commonality criteria indicating a specified communication session participant commonality, or session content correspondence criteria indicating a specified session content commonality.

The session temporal proximity criteria specify a certain temporal proximity between sessions, indicating that sessions occurring close in time may be linked. The session participant commonality criteria within the linkage criteria are parameters used to identify and link network-based communication sessions based on the overlap of participants in those sessions. The session content correspondence criteria within the linkage criteria are parameters that determine the linkage of network-based communication sessions based on the similarity or relatedness of the content discussed, shared, or generated during those sessions. In other examples, additional criteria may be used, such as historical user context criteria as previously described. In some examples, two network-based sessions must satisfy all criteria to be linked. In other examples, satisfying some of, but not all the criteria may be enough to link the sessions. In still other examples, each criteria may be evaluated to produce a score that summarizes how related the sessions are as to that criteria. Each score from each criteria may be combined into a weighted sum to produce a total score. If the total score exceeds a threshold (which may be prespecified by an administrator) the sessions may be linked. The weights may be specified by an administrator, learned by a machine-learning algorithm, or the like.

If the evaluation at operation 512 indicates the sessions are to be linked, then at operation 514, the communication sessions are linked. This may be done by utilizing a pointer or other data field in one or both communication session records, an entry in a special linking table, or the like. If at operation 512 the sessions should not be linked, then at operation 516, the system does not link the records. Method 500 may be repeated for other sets of two or more sessions. In some examples, more than two sessions may be linked and the method of FIG. 5 may be applied for sets of two or more sessions—e.g., the linkage criteria may apply to three sessions.

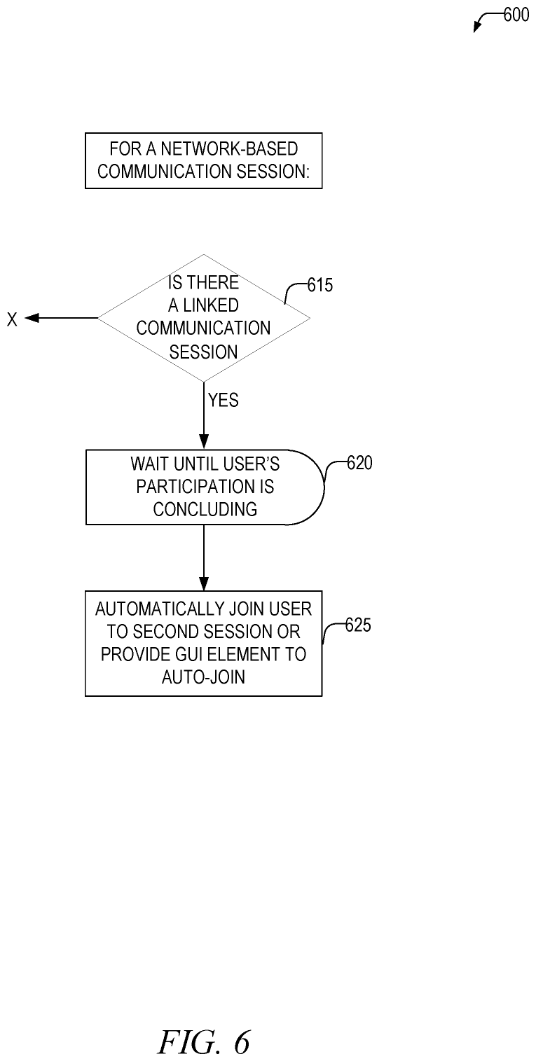

FIG. 6 illustrates a flowchart of a method 600 of providing an automatic join to a linked communication session according to some examples of the present disclosure. During a network-based communication session a determination is made at operation 615 of whether there is a linked network-based communication session. The determination may be made by consulting the linked session field in a record in the communication session (e.g., for the user). In other examples, the determination may be made by consulting other data structures (e.g., a linking database) and the like.

If not, then the method may end. If there is a linked session, then the system may wait until the user's participation in the current session concludes at operation 620. At operation 625, once the user's participation in the session is either concluded, or will conclude shortly (e.g., based upon user input), the system may then the system may automatically join a user to the linked communication session, or may provide a GUI such as shown in FIG. 3 and automatically join the user upon receiving confirmation from the user.

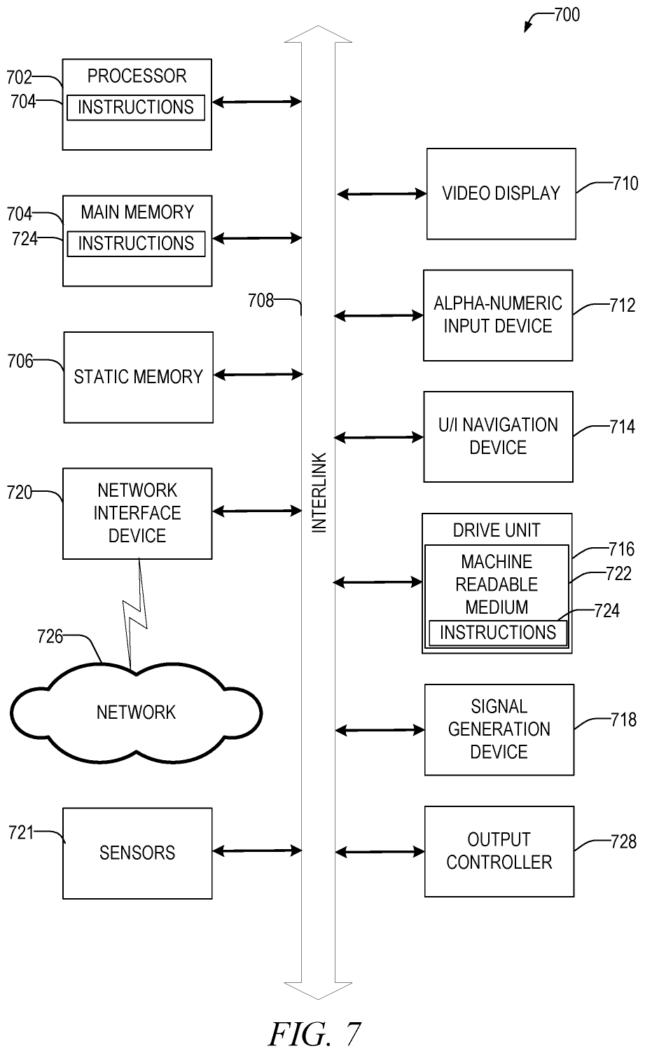

FIG. 7 illustrates a block diagram of an example machine 700 upon which any one or more of the techniques (e.g., methodologies) discussed herein may be performed. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be in the form of a desktop, laptop, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 700 may create, store, index, and manipulate the data structures and artifacts of FIG. 1; be configured to include the components shown in FIG. 2; be configured to be, or be a part of the network-based communication service, participant computing devices, or the like; display the GUIs 310 and 410; and perform the methods of FIGS. 5 and 6.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 700 may include one or more hardware processors, such as processor 702. Processor 702 may be a central processing unit (CPU), a graphics processing unit (GPU), a hardware processor core, or any combination thereof. Machine 700 may include a main memory 704 and a static memory 706, some or all of which may communicate with each other via an interlink (e.g., bus) 708. Examples of main memory 704 may include Synchronous Dynamic Random-Access Memory (SDRAM), such as Double Data Rate memory, such as DDR4 or DDR5. Interlink 708 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 724 may further be transmitted or received over a communications network 726 using a transmission medium via the network interface device 720. The Machine 700 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

### Additional Notes and Examples

Example 1 is a method for linking two network-based communication sessions, the method comprising: using a computer processor: identifying a first and second network-based communication session record, the first and second network-based communication session records describing first and second network-based communication sessions to which a user is invited; identifying that the first network-based communication session record and the second network-based communication session record describe communication sessions that meet one or more contextual linkage criteria, the contextual linkage criteria defining criteria indicating a relatedness of the communication sessions and comprising two or more of: session temporal proximity criteria indicating a specified temporal proximity, session participant commonality criteria indicating a specified communication session participant commonality, or session content correspondence criteria indicating a specified session content commonality; responsive to determining that the first and second network-based communication sessions meet two or more contextual linkage criteria, causing the first and second network-based communication session records to be linked by creating a linkage record in the first or second network-based communication session record; and subsequent to causing the first and second network-based communication session records to be linked, identifying the linkage record prior to a conclusion of a user's participation in the first network-based communication session, and responsive to identifying the linkage record, automatically causing, or providing a prompt that when activated causes the first network-based communication session to end by closing a communication channel between a computing device of the user and the first network-based communication session and joining the second network-based communication session by opening a second communication channel between the computing device of the user and the second network-based communication session.

In Example 2, the subject matter of Example 1 includes, responsive to determining that the first and second network-based communication sessions are linked, concatenating a transcript of the first and second network-based communication sessions to produce a concatenated transcript and providing the concatenated transcript to the user.

In Example 3, the subject matter of Example 2 includes, wherein the concatenated transcript is not provided to a second user that attended only the second network-based communication session.

In Example 4, the subject matter of Examples 2-3 includes, providing the concatenated transcript to a large language model chatbot as context for answering questions in the second network-based communication session, the concatenated transcript allowing the large language model chatbot to answer questions in the second network-based communication session with information discussed in the first network-based communication session.

In Example 5, the subject matter of Examples 1-4 includes, responsive to determining that the first and second network-based communication sessions are linked, concatenating a recording of the first and second network-based communication sessions and providing the concatenated recording to the user.

In Example 6, the subject matter of Examples 1-5 includes, wherein the session temporal proximity criteria comprises a threshold time window.

In Example 7, the subject matter of Examples 1-6 includes, wherein the session content correspondence criteria comprises meeting titles that satisfy a threshold similarity.

Example 8 is a computing device for linking two network-based communication sessions, the computing device comprising: one or more hardware processors; a memory, storing instructions which when executed, performs the operations comprising: identifying a first and second network-based communication session record, the first and second network-based communication session records describing first and second network-based communication sessions to which a user is invited; identifying that the first network-based communication session record and the second network-based communication session record describe communication sessions that meet one or more contextual linkage criteria, the contextual linkage criteria defining criteria indicating a relatedness of the communication sessions and comprising two or more of: session temporal proximity criteria indicating a specified temporal proximity, session participant commonality criteria indicating a specified communication session participant commonality, or session content correspondence criteria indicating a specified session content commonality; responsive to determining that the first and second network-based communication sessions meet two or more contextual linkage criteria, causing the first and second network-based communication session records to be linked by creating a linkage record in the first or second network-based communication session record; and subsequent to causing the first and second network-based communication session records to be linked, identifying the linkage record prior to a conclusion of a user's participation in the first network-based communication session, and responsive to identifying the linkage record, automatically causing, or providing a prompt that when activated causes the first network-based communication session to end by closing a communication channel between a computing device of the user and the first network-based communication session and joining the second network-based communication session by opening a second communication channel between the computing device of the user and the second network-based communication session.

In Example 9, the subject matter of Example 8 includes, wherein the operations further comprise: responsive to determining that the first and second network-based communication sessions are linked, concatenating a transcript of the first and second network-based communication sessions to produce a concatenated transcript and providing the concatenated transcript to the user.

In Example 10, the subject matter of Example 9 includes, wherein the concatenated transcript is not provided to a second user that attended only the second network-based communication session.

In Example 11, the subject matter of Examples 9-10 includes, wherein the operations further comprise: providing the concatenated transcript to a large language model chatbot as context for answering questions in the second network-based communication session, the concatenated transcript allowing the large language model chatbot to answer questions in the second network-based communication session with information discussed in the first network-based communication session.

In Example 12, the subject matter of Examples 8-11 includes, wherein the operations further comprise: responsive to determining that the first and second network-based communication sessions are linked, concatenating a recording of the first and second network-based communication sessions and providing the concatenated recording to the user.

In Example 13, the subject matter of Examples 8-12 includes, wherein the session temporal proximity criteria comprises a threshold time window.

In Example 14, the subject matter of Examples 8-13 includes, wherein the session content correspondence criteria comprises meeting titles that satisfy a threshold similarity.

Example 15 is a machine-readable storage device storing instructions, the instructions when executed by a hardware processor of a machine, causes the machine to perform the operations comprising: identifying a first and second network-based communication session record, the first and second network-based communication session records describing first and second network-based communication sessions to which a user is invited; identifying that the first network-based communication session record and the second network-based communication session record describe communication sessions that meet one or more contextual linkage criteria, the contextual linkage criteria defining criteria indicating a relatedness of the communication sessions and comprising two or more of: session temporal proximity criteria indicating a specified temporal proximity, session participant commonality criteria indicating a specified communication session participant commonality, or session content correspondence criteria indicating a specified session content commonality; responsive to determining that the first and second network-based communication sessions meet two or more contextual linkage criteria, causing the first and second network-based communication session records to be linked by creating a linkage record in the first or second network-based communication session record; and subsequent to causing the first and second network-based communication session records to be linked, identifying the linkage record prior to a conclusion of a user's participation in the first network-based communication session, and responsive to identifying the linkage record, automatically causing, or providing a prompt that when activated causes the first network-based communication session to end by closing a communication channel between a computing device of the user and the first network-based communication session and joining the second network-based communication session by opening a second communication channel between the computing device of the user and the second network-based communication session.

In Example 16, the subject matter of Example 15 includes, wherein the operations further comprise: responsive to determining that the first and second network-based communication sessions are linked, concatenating a transcript of the first and second network-based communication sessions to produce a concatenated transcript and providing the concatenated transcript to the user.

In Example 17, the subject matter of Example 16 includes, wherein the concatenated transcript is not provided to a second user that attended only the second network-based communication session.

In Example 18, the subject matter of Examples 16-17 includes, wherein the operations further comprise: providing the concatenated transcript to a large language model chatbot as context for answering questions in the second network-based communication session, the concatenated transcript allowing the large language model chatbot to answer questions in the second network-based communication session with information discussed in the first network-based communication session.

In Example 19, the subject matter of Examples 15-18 includes, wherein the operations further comprise: responsive to determining that the first and second network-based communication sessions are linked, concatenating a recording of the first and second network-based communication sessions and providing the concatenated recording to the user.

In Example 20, the subject matter of Examples 15-19 includes, wherein the session temporal proximity criteria comprises a threshold time window.

In Example 21, the subject matter of Examples 15-20 includes, wherein the session content correspondence criteria comprises meeting titles that satisfy a threshold similarity.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

What is claimed is:

1. A method for linking two network-based communication sessions, the method comprising:
using a computer processor:
identifying a first and second network-based communication session record, the first and second network-based communication session records describing first and second network-based communication sessions to which a user is invited;
identifying that the first network-based communication session record and the second network-based communication session record describe communication sessions that meet one or more contextual linkage criteria, the contextual linkage criteria defining criteria indicating a relatedness of the communication sessions and comprising two or more of: session temporal proximity criteria indicating a specified temporal proximity, session participant commonality criteria indicating a specified communication session participant commonality, or session content correspondence criteria indicating a specified session content commonality;
responsive to determining that the first and second network-based communication sessions meet two or more contextual linkage criteria, causing the first and second network-based communication session records to be linked by creating a linkage record in the first or second network-based communication session record; and
subsequent to causing the first and second network-based communication session records to be linked, identifying the linkage record prior to a conclusion of a user's participation in the first network-based communication session, and responsive to identifying the linkage record, automatically causing, or providing a prompt that when activated causes the first network-based communication session to end by closing a communication channel between a computing device of the user and the first network-based communication session and joining the second network-based communication session by opening a second communication channel between the computing device of the user and the second network-based communication session.

2. The method of claim 1, further comprising:
responsive to determining that the first and second network-based communication sessions are linked, concatenating a transcript of the first and second network-based communication sessions to produce a concatenated transcript and providing the concatenated transcript to the user.

3. The method of claim 2, wherein the concatenated transcript is not provided to a second user that attended only the second network-based communication session.

4. The method of claim 2, further comprising:
providing the concatenated transcript to a large language model chatbot as context for answering questions in the second network-based communication session, the concatenated transcript allowing the large language model chatbot to answer questions in the second network-based communication session with information discussed in the first network-based communication session.

5. The method of claim 1, further comprising:
responsive to determining that the first and second network-based communication sessions are linked, concatenating a recording of the first and second network-based communication sessions and providing the concatenated recording to the user.

6. The method of claim 1, wherein the session temporal proximity criteria comprises a threshold time window.

7. The method of claim 1, wherein the session content correspondence criteria comprises meeting titles that satisfy a threshold similarity.

8. A computing device for linking two network-based communication sessions, the computing device comprising:
one or more hardware processors;
a memory, storing instructions which when executed, performs the operations comprising:
identifying a first and second network-based communication session record, the first and second network-based communication session records describing first and second network-based communication sessions to which a user is invited;
identifying that the first network-based communication session record and the second network-based communication session record describe communication sessions that meet one or more contextual linkage criteria, the contextual linkage criteria defining criteria indicating a relatedness of the communication sessions and comprising two or more of: session temporal proximity criteria indicating a specified temporal proximity, session participant commonality criteria indicating a specified communication session participant commonality, or session content correspondence criteria indicating a specified session content commonality;
responsive to determining that the first and second network-based communication sessions meet two or more contextual linkage criteria, causing the first and second network-based communication session records to be linked by creating a linkage record in the first or second network-based communication session record; and
subsequent to causing the first and second network-based communication session records to be linked, identifying the linkage record prior to a conclusion of a user's participation in the first network-based communication session, and responsive to identifying the linkage record, automatically causing, or providing a prompt that when activated causes the first network-based communication session to end by closing a communication channel between a computing device of the user and the first network-based communication session and joining the second network-based communication session by opening a second communication channel between the computing device of the user and the second network-based communication session.

9. The computing device of claim 8, wherein the operations further comprise:
responsive to determining that the first and second network-based communication sessions are linked, concatenating a transcript of the first and second network-based communication sessions to produce a concatenated transcript and providing the concatenated transcript to the user.

10. The computing device of claim 9, wherein the concatenated transcript is not provided to a second user that attended only the second network-based communication session.

11. The computing device of claim 9, wherein the operations further comprise:
providing the concatenated transcript to a large language model chatbot as context for answering questions in the second network-based communication session, the concatenated transcript allowing the large language model chatbot to answer questions in the second network-based communication session with information discussed in the first network-based communication session.

12. The computing device of claim 8, wherein the operations further comprise:
responsive to determining that the first and second network-based communication sessions are linked, concatenating a recording of the first and second network-based communication sessions and providing the concatenated recording to the user.

13. The computing device of claim 8, wherein the session temporal proximity criteria comprises a threshold time window.

14. The computing device of claim 8, wherein the session content correspondence criteria comprises meeting titles that satisfy a threshold similarity.

15. A machine-readable storage device storing instructions, the instructions when executed by a hardware processor of a machine, causes the machine to perform the operations comprising:
identifying a first and second network-based communication session record, the first and second network-based communication session records describing first and second network-based communication sessions to which a user is invited;
identifying that the first network-based communication session record and the second network-based communication session record describe communication sessions that meet one or more contextual linkage criteria, the contextual linkage criteria defining criteria indicating a relatedness of the communication sessions and comprising two or more of: session temporal proximity criteria indicating a specified temporal proximity, session participant commonality criteria indicating a specified communication session participant commonality, or session content correspondence criteria indicating a specified session content commonality;
responsive to determining that the first and second network-based communication sessions meet two or more contextual linkage criteria, causing the first and second network-based communication session records to be linked by creating a linkage record in the first or second network-based communication session record; and
subsequent to causing the first and second network-based communication session records to be linked, identifying the linkage record prior to a conclusion of a user's participation in the first network-based communication session, and responsive to identifying the linkage record, automatically causing, or providing a prompt that when activated causes the first network-based communication session to end by closing a communication channel between a computing device of the user and the first network-based communication session and joining the second network-based communication session by opening a second communication channel between the computing device of the user and the second network-based communication session.

16. The machine-readable medium of claim 15, wherein the operations further comprise:
responsive to determining that the first and second network-based communication sessions are linked, concatenating a transcript of the first and second network-based communication sessions to produce a concatenated transcript and providing the concatenated transcript to the user.

17. The machine-readable medium of claim 16, wherein the concatenated transcript is not provided to a second user that attended only the second network-based communication session.

18. The machine-readable medium of claim 16, wherein the operations further comprise:
providing the concatenated transcript to a large language model chatbot as context for answering questions in the second network-based communication session, the concatenated transcript allowing the large language model chatbot to answer questions in the second network-based communication session with information discussed in the first network-based communication session.

19. The machine-readable medium of claim 15, wherein the operations further comprise:
responsive to determining that the first and second network-based communication sessions are linked, concatenating a recording of the first and second network-based communication sessions and providing the concatenated recording to the user.

20. The machine-readable medium of claim 15, wherein the session temporal proximity criteria comprises a threshold time window.
